(19) United States
(12) Patent Application Publication
(10) Pub. No.: US 2001/0024713 A1
(43) Pub. Date: Sep. 27, 2001

(54) Ink jet recording material

(76) Inventors: Dirk Quintens, Westerlo (BE); Horst Friedel, Neuisenburg (DE); Huub Van Aert, Pulderbos (BE); Jan Gilleir, Mortsel (BE)

Correspondence Address: Joseph T. Guy Ph.D., Nexsen Pruet Jacobs & Pollard LLP, 201 W. McBee Avenue, Greenville, SC, 29601, US

(21) Appl. No.: 09/782,835

(22) Filed: Feb. 14, 2001

Related U.S. Application Data
(60) Provisional application No. 60/188,946, filed on Mar. 13, 2000.

(30) Foreign Application Priority Data
Feb. 22, 2000 (EP) 00200600.5

(51) Int. Cl. B32B 3/00

(52) U.S. Cl. 428/195

(57) ABSTRACT

An ink jet recording material is disclosed comprising a support and an ink receiving layer wherein said ink receiving layer comprises (a) a pigment, (b) a silanol modified polyvinyl alcohol, and (c) a film-forming polymer having a glass transition temperature lower than 50° C.

The recording element is especially suited for outdoor use.

### FIELD OF THE INVENTION

The present invention relates to the field of recording media for ink jet printing.

### BACKGROUND OF THE INVENTION

In the majority of applications printing proceeds by pressure contact of an ink-loaden printing form with an ink-receiving material which is usually plain paper. The most frequently used impact printing technique is known as lithographic printing based on the selective acceptance of oleophilic ink on a suitable receptor.

In recent times however so-called non-impact printing systems have replaced classical pressure-contact printing to some extent for specific applications. A survey is given e.g. in the book “Principles of Non Impact Printing” by Jerome L. Johnson (1986), Palatino Press, Irvine, CA 92715, USA.

Among non-impact printing techniques ink jet printing has become a popular technique because of its simplicity, convenience and low cost. Especially in those instances where a limited edition of the printed matter is needed ink jet printing has become a technology of choice. A recent survey on progress and trends in ink jet printing technology is given by Hue P. Le in Journal of Imaging Science and Technology Vol. 42 (1), Jan/Febr 1998.

In ink jet printing tiny drops of ink fluid are projected directly onto an ink receptor surface without physical contact between the printing device and the receptor. The printing device stores the printing data electronically and controls a mechanism for ejecting the drops image-wise. Printing is accomplished by moving the print head across the paper or vice versa. Early patents on ink jet printers include U.S. Pat. No. 3,739,393, U.S. Pat. No. 3,805,273 and U.S. Pat. No. 3,891,121.

The jetting of the ink droplets can be performed in several different ways. In a first type of process a continuous droplet stream is created by applying a pressure wave pattern. This process is known as continuous ink jet printing. In a first embodiment the droplet stream is divided into droplets that are electrostatically charged, deflected and recollected, and into droplets that remain uncharged, continue their way undeflected, and form the image. Alternatively, the charged deflected stream forms the image and the uncharged undeflected jet is recollected. In this variant of continuous ink jet printing several jets are deflected to a different degree and thus record the image (multideflection system).

According to a second process the ink droplets can be created “on demand” (“DOD” or “drop on demand” method) whereby the printing device ejects the droplets only when they are used in imaging on a receiver thereby avoiding the complexity of drop charging, deflection hardware, and ink recollection. In drop-on-demand the ink droplet can be formed by means of a pressure wave created by a mechanical motion of a piezoelectric transducer (so-called “piezo method”), or by means of discrete thermal pushes (so-called “bubble jet” method, or “thermal jet” method).

Ink compositions for ink jet typically include following ingredients : dyes or pigments, water and/or organic solvents, humectants such as glycols, detergents, thickeners, polymeric binders, preservatives, etc. It will be readily understood that the optimal composition of such an ink is dependent on the ink jetting method used and on the nature of the substrate to be printed. The ink compositions can be roughly divided in:

water based ; the drying mechanism involves absorption, penetration and evaporation;

oil based ; the drying involves absorption and penetration;

solvent based ; the drying mechanism involves primarely evaporation;

hot melt or phase change : the ink vehicle is liquid at the ejection temperature but solid at room temperature ; drying is replaced by solidification;

UV-curable ; drying is replaced by polymerization.

It is known that the ink-receiving layers in ink-jet recording elements must meet different stringent requirements :

The ink-receiving layer should have a high ink absorbing capacity, so that the dots will not flow out and will not be expanded more than is necessary to obtain a high optical density.

The ink-receiving layer should have a high ink absorbing speed (short ink drying time) so that the ink droplets will not feather if smeared immediately after applying.

The ink dots that are applied to the ink-receiving layer should be substantially round in shape and smooth at their peripheries. The dot diameter must be constant and accurately controlled.

The receiving layer must be readily wetted so that there is no “puddling”, i.e. coalescence of adjacent ink dots, and an earlier absorbed ink drop should not show any “bleeding”, i.e. overlap with neighbouring or later placed dots.

Transparent ink-jet recording elements must have a low haze-value and be excellent in transmittance properties.

After being printed the image must have a good resistance regarding waterfastness, lightfastness, and good endurance under severe conditions of temperature and humidity.

The ink jet recording element may not show any curl or sticky behaviour if stacked before or after being printed.

The ink jet recording element must be able to move smoothly through different types of printers.

All these properties are often in a relation of trade-off. It is difficult to satisfy them all at the same time.

It is known that the presence in the ink accepting layer of absorptive pigments such as silica, kaolin, talc, aluminum oxide, boehmite, etc. improve the absorption capacity, the obtainable colour density and the drying time. Many patent applications have described this effect for many different binder-systems. U.S. Pat. No. 3,357,846 describes pigments such as kaolin, talc, bariet, TiO₂ used in starch and PVA. U.S. Pat. No. 3,889,270 describes silica in gelatin, PVA and cellulose. Pigments and particles have also been described in patent applications including DE 2,925,769, GB 2,050,866, U.S. Pat. No. 4,474,850, U.S. Pat. No. 4,547,405, U.S. Pat. No. 4,578,285, WO 88 06532, U.S. Pat. No. 4,849,286, EP 339604, EP 400681, EP 407881, EP 411638 and U.S. Pat. No. 5,045,864 (non-exhaustive list).

These particulates are dispersed in various types of binders of which the most common types such as gelatin, polyvinyl alcohol, polyvinyl pyrrolidone, and various types of cellulose derivatives. These conventional binders are mentioned in numerous patent documents.

It is further known to use various types of film-forming polymers to improve the waterfastness of the coated ink receiving layer by increasing its adhesion to the support.

It is also known to improve the waterfastness of the finished printed image by the incorporation of mordanting polymers bearing cationic quaternary groups such as ammonium-, sulphonium and phosphonium groups. These polymers interact with most typical ink jet inks resulting in a better anchoring of the dye in the binder. Typical examples of such descriptions are U.S. Pat. No. 4,371,582, U.S. Pat. No. 4,575,465, U.S. Pat. No. 4,649,064, GB 2 210 071 and EP 423829.

Since the present invention is particularly directed to an improved recording material for outdoor use, such as billboards, banners, signs and advertisement pannels, it will be readily understood that the so-called weatherability characteristics of such a material are of prior importance. These necessary characteristics include excellent waterfastness, lightfastness, and resistance to high and low temperature. A suitable material is disclosed in EP 487350 which describes a receiver coating comprising a pigment, polyvinyl alcohol, and an additional binder selected from the group consisting of styrene-butadiene latices, cationic polymers, styrene-vinyl pyrrolidone copolymers, styrene-maleic anhydride copolymers, and mixtures thereof. However, it turns out that using conventional polyvinyl alcohol as binder not all types of pigments are dispersed in a perfectly stable way. In particular, with some types of silica partial or total flocculation can occur giving rise to turbid coated layers.

The present invention extends the teachings on ink jet recording materials and is particularly directed to to an improved material for outdoor.

### OBJECTS OF THE INVENTION

It is an object of the present invention to provide an ink jet recording material with excellent waterfastness, lightfastness and endurance against extreme conditions of temperature thus making it particularly suited for outdoor use.

It is a further object of the present invention to provide an ink jet recording material comprising an ink receiving layer which is coated from a composition with an improved dispersion stability.

### SUMMARY OF THE INVENTION

The above mentioned objects are realised by providing an ink jet recording element comprising a support and an ink receiving layer wherein said ink receiving layer comprises (a) a pigment, (b) a silanol modified polyvinyl alcohol, and (c) a film-forming polymer having a glass transition temperature lower than 50 ° C.

The recording element may further contain an adhesive undercoat between the support and the ink receiving layer.

### DETAILED DESCRIPTION OF THE INVENTION

We shall now describe in more detail the principal ingredients of the ink receiving layer in connection with the present invention, being the pigment, the silanol modified polyvinyl alcohol, and the film-forming polymer.

The pigment present in the ink receiving layer may be chosen from organic material such as polystyrene, polymethylmethacrylate, silicones, urea-formaldehyde condensation polymers, polyesters and polyamides. Preferably however, it is an inorganic porous pigment, such as silica, talc, clay, koalin, diatomaceous earth, calcium carbonate, magnesium carbonate, aluminium hydroxide, aluminium oxide, titanium oxide, zinc oxide, barium sulfate, calcium sulfate, zinc sulfide, satin white, boehmite and pseudo-boehmite.

The preferred pigment is a silica type, more particularly an amorphous silica having a average particle size ranging from 1 μm to 15 μm, most preferably from 2 to 10 μm. The use of non-colloidal silica types in ink jet receiver formulations is known for long time, e.g. from old references such as JP-A 55-051583, JP-A 56-000157, U.S. Pat. No. 4,474,850 and DE 3410828.

A most useful commercial compound is the amorphous precipitated silica type SIPERNAT 570, trade name from Degussa Co. It is preferably present in the receiving layer in an amount ranging from 5 g/m² to 30 g/m².

The pigment is dispersed into the binder solution by mechanically mixing for about 15 minutes. It is essential to the present invention that this binder is silanol modified polyvinyl alcohol. Most useful commercially available silanol modified polyvinyl alcohols can be found in the POVAL R polymer series, trade name of Kuraray Co., Japan.

A silanol modified polyvinyl alcohol may be obtained via copolymerisation or by modification of the polyvinyl alcohol using silanes. Copolymerisation of vinyl acetate with monomers like vinyltrimethoxysilane, methacroyloxypropyl trimethoxysilane, triisopropoxyvinylsilane, and methacrylamidopropyl triethoxysilane can result in useful precursor polymers. The polyvinyl alcohol may also be modified using silanes. Alkoxy silanes like β-3,4-epoxycyclohexylethyltriethoxysilane, γ-glycidyloxypropyltrimethoxysilane or isocyanatopropyl triethoxysilane are suitable for this purpose.

It is not excluded that a minor amount of another conventional binder is admixed to the silanol modified polyvinyl alcohol as long as the latter remains the principal binder. Typical binders, well-known in the art include hydroxyethyl cellulose; hydroxypropyl cellulose; hydroxyethylmethyl cellulose; hydroxypropyl methyl cellulose; hydroxybutylmethyl cellulose; methyl cellulose; sodium carboxymethyl cellulose; sodium carboxymethylhydroxethyl cellulose; water soluble ethylhydroxyethyl cellulose; cellulose sulfate; polyvinyl alcohol; vinylalcohol copolymers; polyvinyl acetate; polyvinylacetal; polyvinyl pyrrolidone; polyacrylamide; acrylamide/acrylic acid copolymer; styrene/acrylic acid copolymer; ethylene-vinylacetate copolymer; vinylmethyl ether/maleic acid copolymer; poly(2-acrylamido-2-methyl propane sulfonic acid); poly(diethylene triamine-co-adipic acid); polyvinyl pyridine; polyvinyl imidazole; polyimidazoline quaternized; polyethylene imine epichlorohydrin modified; polyethylene imine ethoxylated; poly(N,N-dimethyl-3,5-dimethylene piperidinium chloride; polyethylene oxide; polyurethane; melamine resins; gelatin; carrageenan; dextran; gum arabic; casein; pectin; albumin; starch; collagen derivatives; collodion and agar-agar.

The binder or binder mixture is preferably present in the receiving layer in a weight ratio from 30% to 60% to the total coating weight of the layer.

The third essential ingredient of the receiving layer according to the present invention is a film-forming polymer having a glass transition temperature (Tg) lower than 50° C., more preferably lower than 20° C. It is added whilst stirring to the dispersion of the pigment in the binder.

The presence of such a polymer has several benefits. It gives cohesive strength between the pigment particles. This reduces dust formation on scratching and gives rise to good wet adhesion properties. The low Tg gives rise to a certain amount of elasticity so that the material can be stretched without inducing cracks.

Representative polymers obeying this definition include conjugated diene polymers such as styrene-butadiene copolymers and methyl methacrylate-butadiene copolymers, acrylic polymers, for example, homopolymers and copolymers of acrylic acid esters and methacrylic acid esters, vinyl polymers, e.g. butadiene-acrylonitrile copolymers, and polyurethane or urethane/acrylic hybrids; vinylester polymers, for example, polyvinyl acetate, ethylene-vinyl acetate copolymers; vinylacetate-acrylate copolymers, vinylacetate-maleate copolymers; modification reaction products of the above-mentioned polymers and copolymers, for example, modified with a carboxyl and/or cationic groups; water-soluble or dispersible resins, for example, melamine-formaldehyde resins and urea-formaldehyde resins; water-insoluble adhesive resins, for example, maleic anhydride copolymer resins, polyacrylamide resins, polymethyl methacrylate resins, polyurethane resins, unsaturated polyester resins, polyvinyl butyral resins, and alkyd resins.

Preferably, the film-forming polymer is a latex. The most preferred latices are copoly(styrene-butadiene) latices, (co)polyvinylester latices, and (co)polyacrylate latices.

Further useful latices include aqueous aliphatic urethane dispersions; vinylacetate, and copolymers, such as copoly(vinylacetate-butylmaleate), copoly(vinylacetate-acrylate), copoly(vinylacetate-ethylene), and vinylacetate-vinylidenechloride; and copoly(acrylonitrile-butadiene).

The film-forming polymer is incorporated in the ink-receiving layer in a preferred weight % range from 5 to 20%.

The total dry coating weight of the receiving layer is preferably comprised between 10 and 40 g/m².

Apart from the three essential ingredients a cationic substance acting as mordant may be present in the ink receiving layer. Such substances increase the capacity of the layer for fixing and holding the dye of the ink droplets. A particularly suited compound is a poly(diallyldimethylammonium chloride) or, in short, a poly(dadmac). These compounds are commercially available from several companies, e.g. Aldrich, Calgon, Clariant, BASF and EKA Chemicals.

Other useful cationic compounds include dadmac copolymers such as copolymers with acrylamide; dimethylamine-epichlorohydrine, e.g. POLYFIX 601, trade name of Showa Highpolymer Co., NEOFIX E-117, trade name of Nicca Chemical Co., a polyoxyalkylene polyamine dicyanodiamine, and REDIFLOX 4150, trade name of EKA Chemicals; MADAME (methacrylatedimethylaminoethyl =dimethylaminoethyl methacrylate) or MADQUAT (methacryloxyethyltrimethylammonium chloride) modified polymers; e.g. ROHAGIT KL280, ROHAGIT 210, ROHAGIT SL144, PLEX 4739L, PLEX 3073 from Rohm, DIAFLOC KP155 and other DIAFLOC products from Diafloc Co., BMB 1305 and other BME products from EKA chemicals; cationic epichlorohydrin adducts such as POLYCUP 171 and POLYCUP 172, trade names from Hercules Co.; from Cytec industries : CYPRO products, e.g. CYPRO 514/515/516, SUPERFLOC 507/521/567; cationic cellulose derivatives such as CELQUAT L-200, H-100, SC-240C, SC-230M, trade names of Starch & Chemical Co., and QUATRISOFT LM200, UCARE polymers JR125, JR400, LR400, JR30M, LR30M and UCARE polymer LK; trivalent aluminum, boron, and zirconium ions; polyethyleneimine and copolymers, e.g. LUPASOL, trade name of BASF AG; triethanolamine-titanium-chelate, e.g. TYZOR, trade name of Du Pont Co.; copolymers of vinylpyrrolidone such as VIVIPRINT 111, trade name of ISP, a methacrylamido propyl dimethylamine copolymer; with dimethylaminoethylmethacrylate such as COPOLYMER 845 and COPOLYMER 937, trade names of ISP; with vinylimidazole, e.g. LUVIQUAT CARE, LUVITEC 73W, LUVITEC VPI55 K18P, LUVITEC VP155 K72W, LUVIQUAT FC905, LUVIQUAT FC550, LUVIQUAT HM522, and SOKALAN HP56, all trade names of BASF AG; polyamidoamines, e.g. RETAMINOL and NADAVIN, trade marks of Bayer AG; and phosphonium compounds such as disclosed in EP 609930.

In an alternative embodiment the cationic substance is not incorporated in the ink receiving layer itself but in a separate thin top layer. In this case this layer is coated from an aqueous medium. Its dry coverage is preferably comprised between 0.5 and 5 g/m².

Depending on the surface properties of the substrate an extra adhesive layer may be applied between the support and the ink receiving layer. This layer is then coated from an aqueous medium containing any of the numerous known adhesive polymers. In a preferred embodiment the adhesive polymer is also a styrene-butadiene latex or an acrylate latex. The dry coating weight of this undercoat layer when present is preferably comprised between 0.5 and 10 g/m².

The ink receiving layer and the optional top- and undercoat layers may further contain well-known conventional ingrediënts, such as surfactants serving as coating aids, hardening agents plasticizers, whitening agents and matting agents.

Surfactants may be incorporated in the ink-receiving layer of the present invention. They can be any of the cationic, anionic, amphoteric, and nonionic ones as described in JP-A 62-280068 (1987). Examples of the surfactants are N-alkylamino acid salts, alkylether carboxylic acid salts, acylated peptides, alkylsulfonic acid salts, alkylbenzene and alkylnaphthalene sulfonic acid salts, sulfosuccinic acid salts, α-olefin sulfonic acid salts, N-acylsulfonic acid salts, sulfonated oils, alkylsulfonic acid salts, alkylether sulfonic acid salts, alkylallylethersulfonic acid salts, alkylamidesulfonic acid salts, alkylphosphoric acid salts, alkyletherphosphoric acid salts, alkylallyletherphosphoric acid salts, alkyl and alkylallylpolyoxyethylene ethers, alkylallylformaldehyde condensed acid salts, alkylallylethersulfonic acid salts, alkylamidesulfonic acid salts, alkylphosphoric acid salts, alkyletherphosphoric acid salts, alkylallyletherphosphoric acid salts, alkyl and alkylallylpolyoxyethylene ethers, alkylallylformaldehyde condensed polyoxyethylene ethers, blocked polymers having polyoxypropylene, polyoxyethylene polyoxypropylalkylethers, polyoxyethyleneether of glycolesters, polyoxyethyleneether of sorbitanesters, polyoxyethyleneether of sorbitolesters, polyethyleneglycol aliphatic acid esters, glycerol esters, sorbitane esters, propyleneglycol esters, sugaresters, fluoro C₂-C₁₀ alkylcarboxylic acids, disodium N-perfluorooctanesulfonyl glutamate, sodium 3-(fluoro-C₆-C₁₁alkyl-oxy)-1-C₃-C₄ alkyl sulfonates, sodium 3-(ω-fluoro-C₆-C₈ alkanoyl-N-ethylamino)-1-propane sulfonates, N-[3-(perfluorooctanesulfonamide)-propyl]-N,N-dimethyl-N-carboxymethylene ammonium betaine, fluoro-C₁₁-C₂₀ alkylcarboxylic acids, perfluoro C₇-C₁₃ alkyl carboxylic acids, perfluorooctane sulfonic acid diethanolamide, Li, K and Na perfluoro C₄-C₁₂ alkyl sulfonates, N-propyl-N-(2-hydroxyethyl)perfluorooctane sulfonamide, perfluoro C₆-C₁₀ alkylsulfonamide propyl sulfonyl glycinates, bis-(N-perfluorooctylsulfonyl-N-ethanolaminoethyl)phosphonate, mono-perfluoro C₆-C₁₆ alkyl-ethyl phosphonates, and perfluoroalkylbetaine.

Especially useful are the fluorocarbon surfactants as described in e.g. U.S. Pat. No. 4,781,985, having a structure of F(CF₂)₄₋₉CH₂CH₂SCH₂CH₂N⁺R₃X⁻wherein R is an hydrogen or an alkyl group; and in U.S. Pat. No. 5,084,340, having a structure of: CF₃(CF₂)ₘCH₂CH₂O(CH₂CH₂O)ₙ R wherein m=2 to 10; n=1 to 18; R is hydrogen or an alkyl group of 1 to 10 carbon atoms. These surfactants are commercially available from DuPont and 3M. The concentration of the surfactant component in the ink-receiving layer is typically in the range of 0.1 to 2%, preferably in the range of 0.4 to 1.5% and is most preferably 0.75% by weight based on the total dry weight of the layer.

The ink-receiving layer according to this invention is preferably crosslinked to provide such desired features as waterfastness and non-blocking characteristics. The crosslinking is also useful in providing abrasion resistance and resistance to the formation of fingerprints on the element as a result of handling. There are a vast number of known crosslinking agents—also known as hardening agents—that will function to crosslink film forming materials, and they are commonly used in the photographic industry to harden gelatin emulsion layers and other layers of photographic silver halide elements.

Hardening agents can be used individually or in combination and in free or in blocked form. A great many hardeners, useful for the present invention, are known, including formaldehyde and free dialdehydes, such as succinaldehyde and glutaraldehyde, blocked dialdehydes, active esters, sulfonate esters, active halogen compounds, isocyanate or blocked isocyanates, polyfunctional isocyanates, melamine derivatives, s-triazines and diazines, epoxides, active olefins having two or more active bonds, carbodiimides, isoxazolium salts unsubsituted in the 3-position, esters of 2-alkoxy-N-carboxy-dihydroquinoline, N-carbamoylpyridinium salts, hardeners of mixed function, such as halogen-substituted aldehyde acids (e.g. mucochloric and mucobromic acids), onium substituted acroleins and vinyl sulfones and polymeric hardeners, such as dialdehyde starches and copoly(acroleinmethacrylic acid), and oxazoline functional polymers, e.g. EPOCROS WS-500, and EPOCROS K-1000 series.

Matting agents may be added such as polymethylmethacrylate beads. They are usually added to the receiving layer in a range of 0.4 to 1.2 g/m² and preferably in a range of 0.40 to 0.90 g/m² with 0.50 g/m² being most preferred.

When the element is intended for viewing in reflection, the ink-receiving layer of the invention may contain a whitening agent. TiO₂ (rutile or anatase) is preferably used as whitening agent.

The ink-receiving layer of the present invention may also comprise a plasticizer such as ethylene glycol, diethylene glycol, propylene glycol, polyethylene glycol, glycerol monomethylether, glycerol monochlorohydrin, ethylene carbonate, propylene carbonate, tetrachlorophthalic anhydride, tetrabromophthalicanhydride, urea phosphate, triphenylphosphate, glycerolmonostearate, propylene glycol monostearate, tetramethylene sulfone, n-methyl-2-pyrrolidone, n-vinyl-2-pyrrolidone.

The ink receiving layer and the optional supplementary layers can be coated onto the support by any conventional coating technique, such as dip coating, knife coating, extrusion coating, spin coating, slide hopper coating and curtain coating.

The support for use in the present invention can be chosen from the paper type en polymeric type support well-known from photographic technology. Paper types include plain paper, cast coated paper, polyethylene coated paper and polypropylene coated paper. Polymeric supports include cellulose acetate propionate or cellulose acetate butyrate, polyesters such as polyethylene terephthalate and polyethylene naphthalate, polyamides, polycarbonates, polyimides, polyolefins, poly(vinylacetals), polyethers and polysulfonamides. Other examples of useful high-quality polymeric supports for the present invention include opaque white polyesters and extrusion blends of poly(ethylenenterephthalate) and polypropylene. Polyester film supports and especially polyethylene terephthalate are preferred because of their excellent properties of dimensional stability. When such a polyester is used as the support material, a subbing layer must be employed to improve the bonding of the ink-receiving layer to the support. Useful subbing layers for this purpose are well known in the photographic art and include, for example, polymers of vinylidene chloride such as vinylidene chloride /acrylonitrile /acrylic acid terpolymers or vinylidene chloride /methyl acrylate /itaconic acid terpolymers.

Typical supports for outdoor use include PET, wet strength paper, PVC, PVC with an adhesive backing, the polyethylene paper TYVEK, trade name of Du Pont Co., the porous polyethylene paper TESLIN, trade name of International Paper CO., canvas, polypropylene, and polycarbonate.

The present invention will now be illustrated by the following examples without however being limited thereto.

### EXAMPLES

### Example 1

The following types of polyvinyl alcohol (PVA) were tested in the experiments described furtheron (table 1).

TABLE 1

| | | | hydrolysis | viscosity | |
|---|---|---|---|---|---|
| No. | name | firm | (%) | 4% 20° C. | comonomer |
| 1 comp. | Gohsefimer | Nippon | 85-88 | 18-22 | dadmac* |
| | K-210 | Goshei | | | |
| 2 comp. | PolyviolWX | Wacker | 97-99 | 43-53 | — |
| | 48/20 | | | | |
| 3 comp. | Airvol 230 | Air | 87-89 | 3.5-4.5 | — |
| | | Products | | | |
| 4 inv. | PovalR2105 | Kuraray | 98-99 | 4.8 | silanol** |
| 5 inv. | PovalR1130 | ″ | ″ | 25.6 | ″ |
| 6 inv. | PovalR3109 | ″ | ″ | 9.7 | ″ |

*diallyldimethylammonium chloride
**vinyltrimethoxysilane

The silica type SIPERNAT 570, trade mark of Degussa Co., was added to solutions of the different polyvinyl alcohol types in amounts represented in table 2. Dispersions were prepared using a pendraulic dissolver for about 15 minutes.

The quality of the dispersions was determined using microscopical evaluation of the flocculation degree. The results are summarized in table 2.

TABLE 2

| Sample | | | |
|---|---|---|---|
| No. | g SIPERNAT | g PVOH | microscop eval. |
| 1 | 400 g | 600 g of 10% sol. PVA 1 | moderate floc.* |
| 2 | ″ | 1090 g of 5.5% sol. PVA 2 | strong floc. |
| 3 | ″ | 1090 g of 5.5% sol. PVA 3 | strong floc. |
| 4 | 200 g | 545.5 g of 5.5% sol. PVA 4 | no floc. |
| 5 | 400 | 1090 g of 5.5% sol. PVA 5 | little floc. |

It is clear that the samples with silanol modified polyvinyl alcohol gave the best result.

The solution were prepared by adding 916 g of each dispersion 84 g of the styrene-butadiene latex DL379, trade name of Dow Co.

After addition of an anionic surfactant the solutions were coated on a subbed polyester base at a wet thickness of abour 120 μm.

The samples coated from solutions with flocculation showed a marginal cohesive strength of the ink receptive layer.

The samples were printed with an Encad Novajet 42 ink jet printer by means of GO inks on the base of pigments. The densities are illustrated in table 3.

TABLE 3

| Sample No. | cyan | magenta | yellow | black |
|---|---|---|---|---|
| 1 | 0.93 | 0.79 | 0.77 | 1.08 |
| 2 | 0.64 | 0.58 | 0.54 | 0.92 |
| 3 | 0.54 | 0.49 | 0.53 | 0.91 |
| 4 | 1.20 | 1.07 | 1.01 | 1.29 |
| 5 | 0.97 | 0.88 | 0.85 | 1.28 |

The samples containing the dispersions with modified polyvinyl alcohol (PVA) gave the highest densities.

### Example 2

The experiment was repeated with other types of PVA. Solutions were prepared by adding 469.4 ml of water to 300 ml of 10% solutions 20 of the different PVA types combined with 203 g of SIPERNAT 570, trade name from Degussa. The dispersions were mixed for about 15 minutes with an Ultraturrax. Then 120 ml of Dow latex DL950 was added. The mixtures were coated on subbed polyester at a wet thickness of 120 μm. The samples were printed on an Encad Novajet 25 with GO pigment inks. The densities obtained are summarized in table 4.

TABLE 4

| PVA type | cyan | magenta | yellow | black |
|---|---|---|---|---|
| 1 | 0.79 | 0.69 | 0.69 | 0.96 |
| 3 | 0.67 | 0.61 | 0.55 | 0.87 |
| 6 | 0.62 | 0.58 | 0.57 | 0.94 |

Again the samples with modified PVA gave better densities.

### Example 3

This example illustrates the benefits of an adhesive undercoat. Again 300 ml of a 10% PVA solution was combined with 230 g of SIPERNAT, trade name of Degussa Co., and 469.4 ml of water were added. Then 120 ml of Dow latex DL950 was added. The solutions were coated respectively:

(1) on a PVC support without extra layer;

(2) on a PVC support provided with an adhesive layer containing styrene-butadiene latex DL950, trade name of Dow Co.;

(3) on a PVC support provided with an adhesive layer containing a copolymer of ethylacrylate and hydroxyethylmethacrylate (HEMA).

The samples were put in water for 10 minutes at 30° C. Then the samples were rubbed with a sponge and visually judged for damages. A qualitative evaluation for wet adhesion was given according to an arbitrary scale ranging from 1 (no damage) to 4 (complete removal of the layer). The samples were also judged for dry adhesion by a cross cut. The results are summarized in table 5.

TABLE 5

| coated sample | wet adhesion | dry adhesion |
|---|---|---|
| (1) | 4 | 4 |
| (2) | 1 | 2-3 |
| (3) | 1 | 1-2 |

Is clear that the presence of an adhesive undercoat improves the adhesion characteristics.

### Example 4

This example illustrates the benefits of an extra top layer comprising a cationic polymer such as poly(diallyldimethylammonium chloride).

Sample (2) of example 3 was provided with a top layer coated from a 6.25% solution of poly(diallyldimethylammonium chloride). The compound used was CATFLOC T2, trade name from Calgon Co. This sample and a comparison sample without the extra top layer were printed with an AgfaJet Sherpa, trade name of Agfa-Gevaert N.V., using 4 colour dye inks. The obtained densities were measured on a Macbeth densitometer in reflection. Then the samples were put in water for 30 minutes, and the densities were measured again. The results are summarized in table 6.

TABLE 6

| | Y | M | C | K |
|---|---|---|---|---|
| comparison | | | | |
| fresh | 1.14 | 1.11 | 1.31 | 1.41 |
| after 30 min H20 | 0.02 | 0.01 | 0.04 | 0.04 |
| with top layer | | | | |
| fresh | 1.18 | 1.22 | 1.40 | 1.43 |
| after 30 min H20 | 1.14 | 1.20 | 1.45 | 1.42 |

It is clear that the sample comprising the extra top layer with the poly(diallyldimethylammonium chloride) polymer retained its colour densities after the water treatment, which is not the case for the comparison sample without the extra top layer.

1. An ink jet recording element comprising a support and an ink receiving layer wherein said ink receiving layer comprises (a) a pigment, (b) a silanol modified polyvinyl alcohol, and (c) a film-forming polymer having a glass transition temperature T_{g} lower than 50 ° C.

2. An ink jet recording element according to claim 1 wherein said pigment is a porous inorganic pigment.

3. An ink jet recording element according to claim 2 wherein said porous inorganic pigment is a silica.

4. An ink jet recording element according to claim 1 wherein said silica is an amorphous silica having an average particle size between 1 μm and 15 μm.

5. An ink jet recording element according to claim 1 wherein said silanol modified polyvinyl alcohol has a silanol modification degree between 0.1% and 10% and a viscosity of a 4% aqueous solution between 1 and 25 mpa.s.

6. An ink jet recording element according to claim 1 wherein said film-forming polymer having a T_{g} lower than 50 ° C. is a latex.

7. An ink jet recording element according to claim 6 wherein said latex is a copoly(styrene-butadiene) latex.

8. An ink jet recording element according to claim 6 wherein said latex is an acrylate latex.

9. An ink jet recording element according to claim 1 wherein said ink receiving layer further comprises a cationic substance.

10. An ink jet recording element according to claim 9 wherein said cationic substance is a poly(diallyldimethylanmonium chloride) or a dimethylamine-epichlorohydrine copolymer.

11. An ink jet recording element according to claim 1 wherein said element further comprises an adhesive undercoat layer containing an adhesive polymer between said support and said ink receiving layer.

12. An ink jet recording element according to claim 11 wherein said adhesive polymer is a copoly(styrene-butadiene) latex.

13. An ink jet recording element according to claim 11 wherein said adhesive polymer is an acrylate latex.

14. An ink jet recording element according to claim 13 wherein said acrylate latex is ethylacrylate-hydroxyethylmethacrylate copolymer.

15. An ink jet recording element according to claim 11 wherein said adhesive polymer is a vinylester latex.

16. An ink jet recording element according to claim 1 wherein said support is an opaque support.
